(19) United States
(12) Patent Application Publication
(10) Pub. No.: US 2012/0012540 A1
(43) Pub. Date: Jan. 19, 2012

(54) GRIT REMOVAL SYSTEM

(75) Inventors: Peter Kotelko, Vegreville (CA); Mike Kotelko, Vegreville (CA); George Caraganis, Sherwood Park (CA); Glen Foster, Winnipeg (CA)

(73) Assignee: HIGHMARK RENEWABLES RESEARCH , L.P.

(21) Appl. No.: 13/182,626

(22) Filed: Jul. 14, 2011

Related U.S. Application Data
(60) Provisional application No. 61/364,861, filed on Jul. 16, 2010.

(51) Int. Cl. B01D 21/06; C02F 1/00; C02F 11/04; B01D 21/02

(52) U.S. Cl. 210/803; 210/532.1; 210/533; 210/523; 210/530; 210/112; 210/197; 210/195.1

(57) ABSTRACT

A grit removal system for tanks with a need to remove settled solids (e.g., anaerobic digester tank) is described. The system is especially suitable for a large tank, preferably having a flat floor, and it works well while submerged under a liquid. Specifically, a periphery-driven rack & pinion mechanism drives a shaft to rotate about a center pivot, and scrapes settled solids towards tank periphery, where the solids fall into a pit on the tank floor. A drainage opening inside the pit, when opened by a valve, is used to flush out the solids through a standpipe into a settlement tank for final dewatering and solid disposal. The system is compatible for continuous tank operation, and is useful for stirring tanks requiring periodic sediment removal.

### REFERENCE TO RELATED APPLICATIONS

This application claims the benefit of the filing date of U.S. Provisional Application No. 61/364,861 under 35 U.S.C. 119(e), filed on Jul. 16, 2010, the entire content of which, including the specification and the drawings, is hereby incorporated by reference.

### BACKGROUND OF THE INVENTION

Settled solids (such as “grit”) on the floor of many tank systems usually require periodic cleaning, or, accumulation of such settled solids will eventually impair tank operation. The cleaning process can be quite inconvenient, and may require first removing all the liquid (and/or gas) in the tank system, thus shutting down tank operation. This is especially inconvenient and expensive for tank systems operating on continuous mode or semi-continuous mode.

For example, in an anaerobic digester tank, there are usually significant amount of undigestable solids (including rocks, stones, sands, metal objects, or other undigestable organic or inorganic foreign objects) that tend to settle on the tank floor. Such solids range in size from minute sand particles to objects a few inches across. The amount and type of such settled solids depends partly on the source of the organic waste. Regardless of the type and amount of such solids, however, accumulation of the solids on the tank floor needs to be cleaned up periodically before such accumulation eventually impacts tank and/or process operation.

Cleaning the settled solids on the tank floor usually requires shutting down the anaerobic digester tank, venting all the liquid and (noxious and/or toxic) gas content of the tank, before settled solids on the tank floor can be accessed and removed. Furthermore, after the cleaning process is complete, restarting the anaerobic digester to reach peak performance requires an additional lag time. Therefore, the whole cleaning process usually requires weeks of tank down time, leading to significant operational and economical disadvantages. The same type of problem may also exist in bioreactors and other tank systems.

### SUMMARY OF THE INVENTION

The invention described herein provides systems and methods for effectively removing solids settled at the bottom of a tank (e.g., an anaerobic digester tank), preferably on a continuous basis, preferably without the need to shut down the tank or otherwise negatively impact the normal operation of the tank or in some cases to extend the interval between cleaning the tank.

Thus, in one aspect, the invention provides a solid removal system for removing solids settled at the bottom of a tank containing a solid-liquid mix, the system comprising: (a) a pit located at the bottom of the tank, for receiving the solids; and, (b) a standpipe having an opening within the pit, and a discharge mechanism that controls the discharge of the solids through the opening; wherein the standpipe is designed such that internal pressure of the tank alone is sufficient to allow the solids to discharge through the standpipe.

In certain embodiments, the height of the standpipe is at least about 25 feet, 30 feet, 40 feet, 45 feet, or 50 feet.

In certain embodiments, the standpipe is designed to operate with at least about 10 psi, 15 psi, 20 psi, 25 psi or more of internal pressure of the tank.

In certain embodiments, the tank is pressurized.

In certain embodiments, the tank is at atmospheric pressure.

In certain embodiments, the standpipe is connected to the opening within the pit through a proximal pipe, and connected to a discharge tank for receiving the solids through a distal pipe.

In certain embodiments, the discharge mechanism comprises: (a) a first valve on the proximal pipe that controls the flow from the opening to the standpipe; and, (b) a second valve on the distal pipe that controls the flow from the standpipe to the discharge tank.

In certain embodiments, the first valve and the second valve are designed not to open at the same time.

In certain embodiments, at least one of the first valve and the second valve is automated.

In certain embodiments, the discharge tank comprises a high-low level control for controlling the opening of the second valve, such that the second valve is designed not to open when the contents in the discharge tank is at or higher than a pre-determined volume.

In certain embodiments, the discharge mechanism comprises a third valve for preventing the flow or controlling the level of flow from the opening to the standpipe.

In certain embodiments, the top of the standpipe further comprises a return pipe for returning excessive contents back to the tank.

In certain embodiments, the system further comprises a settled-solid moving system configured to move solids settled at the bottom of the tank towards the pit.

In certain embodiments, the settled-solid moving system comprises: (a) a rack, as a part of a rack and pinion assembly, disposed around an inner periphery of the tank; (b) a center pivot disposed substantially vertically and substantially centrally within the tank; (c) a shaft configured to rotate around the center pivot, the shaft comprising a solid-moving mechanism configured to move solids settled at the bottom of the tank towards the pit, and the shaft is: (1) at the proximal end, rotatably connected to the center pivot, and (2) at the distal end, engaged to a pinion of the rack and pinion assembly, (d) a power source (e.g., a hydraulic motor) configured to drive the pinion to move along the rack.

In certain embodiments, the rack and pinion assembly is submerged when the tank is filled with the solid-liquid suspension.

In certain embodiments, the teeth of the rack point downward to engage the pinion.

In certain embodiments, the rack is fixed on the bottom of the tank, or on the wall of the tank.

In certain embodiments, the shaft is hollow.

In certain embodiments, the solid-moving mechanism comprises a plurality of scraping blades, each arranged at an angle not perpendicular to the axis of the shaft.

In certain embodiments, all the scraping blades are parallel to each other.

In certain embodiments, at least two of the plurality of scraping blades are not parallel to each other.

In certain embodiments, the angle of each scraping blade is individually adjustable.

In certain embodiments, the solid-moving mechanism comprises a scraping cup at the distal end of the shaft, wherein solids trapped in the scraping cup are positioned to fall into the pit when the distal end of the shaft passes over the pit.

In certain embodiments, the shaft is longer than 20, 30, 40, 50, or 60 ft.

In certain embodiments, the power source is configured to drive the pinion to move along the rack in either direction.

In certain embodiments, the center pivot comprises a multi-port hydraulic swivel to provide torque.

In certain embodiments, settled-solid moving system comprises two or more shafts.

In certain embodiments, the bottom of the tank is flat or substantially flat.

In certain embodiments, the bottom of the tank is not flat, such as cone shaped or reserve cone shaped with a raised center.

In certain embodiments, the system further comprises a water jet in the pit to assist the flushing of solids in the pit through the standpipe.

In certain embodiments, the system comprises two or more pits.

In certain embodiments, the tank is an anaerobic digestor tank, and the solid-liquid mix is organic waste undergoing anaerobic digestion.

In certain embodiments, the system is configured to operate and remove solids settled at the bottom of the tank during an active anaerobic digestion.

In certain embodiments, the solids settled at the bottom of the tank comprise rock, stone, metal, and other inorganic material not conductive for anaerobic digestion.

In certain embodiments, the system operates when the solid-liquid suspension in the tank is being stirred.

In certain embodiments, the standpipe is configured to accelerate the initial discharge of the settled solids under the pressure of the solid-liquid suspension, and configured to prevent excessive discharge when the level in the standpipe approaches the solid-liquid suspension level inside the tank.

In certain embodiments, discharge of the settle solids is not assisted by any power source (e.g., a pump).

In certain embodiments, the standpipe is connected to a discharge tank for receiving solids removed from the tank.

In certain embodiments, the discharge tank comprises a stirring mechanism.

In certain embodiments, the discharge tank is configured to return a liquid and/or a gas back to the tank.

In certain embodiments, settled solids in the discharge tank are discharged via a screw conveyer.

Another aspect of the invention provides a method for removing solids settled at the bottom of a tank containing a solid-liquid mix, the method comprising: (a) collecting the solids in a pit located at the bottom of the tank; and, (b) discharging the solids in the pit through an opening of a standpipe, the opening is inside the pit, and the open and closure of the opening is controlled by a discharge mechanism; wherein the standpipe is designed such that internal pressure of the tank alone is sufficient to allow the solids to discharge through the standpipe.

In certain embodiments, the discharge mechanism comprises: (a) a first valve on a proximal pipe that controls the flow from the opening to the standpipe; and, (b) a second valve on a distal pipe that controls the flow from the standpipe to a discharge tank; wherein the first valve and the second valve are designed not to open at the same time.

In certain embodiments, step (b) is effected by: (1) opening the first valve to allow the liquid pressure inside the tank to flush the solids in the pit to the standpipe; (2) closing the first valve and opening the second valve to allow the pressure inside the standpipe to flush the solids in the standpipe to the discharge tank.

In certain embodiments, the solids are collected in the pit using a settled-solid moving system configured to move solids settled at the bottom of the tank towards the pit.

While features of the embodiments herein may be described separately, it is contemplated that any embodiments described herein, including those described under different aspects (e.g., methods of use and systems) of the invention, can be combined with any one or more other embodiments where applicable or not specifically prohibited.

### BRIEF DESCRIPTION OF THE DRAWING

FIG. 1 is a schematic drawing (not necessarily to scale) that illustrates a representative embodiment of the invention. Partially shown is a cut-off view of a digestor tank wall 1. At the bottom of the digestor tank, and close to the periphery of the tank, is a discharge outlet or “pit” 2 for receiving settled solids scraped into the pit by the solid removal system (not shown). A horizontal pipe 3 is connected to the pit 2. Along the pipe 3 is a first valve 4 and a second valve 5, which are followed by the standpipe 6 and a third valve 8. The pipe 3 continues on to a discharge tank (not sown). The standpipe 6 shown has an optional return 7 that goes back to the tank wall 1 need the tank roof. All actual measures in the drawing are for illustrative purpose only, and are not intended to be limiting.

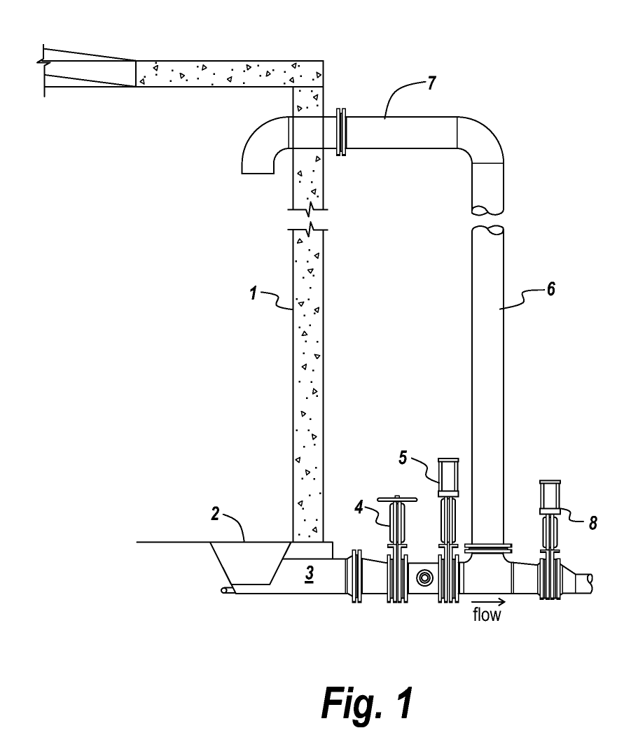

### DETAILED DESCRIPTION OF THE INVENTION

One salient feature of the invention takes advantage of the internal pressure of a tank, in conjunction with a standpipe for periodically remove solids settled at the bottom of the tank through a solid removal system.

As used herein, “internal pressure of a tank” refers to the pressure difference at the point the standpipe opens to the tank. Depending on the design of the tank, it may include the combined liquid head pressure (generated by any liquids inside the tank) and the pressure at the top of the liquid in the tank (if any), minus any combined pressure (liquid and/or gas) inside the standpipe. For example, the tank may be an atmospheric tank, and the accumulative pressure at the bottom of the atmospheric tank, where the standpipe connects, is up to the combined pressure of the atmosphere and the liquid pressure of the tank. The tank may also be a sealed tank under gas pressure (such as pressure generated by gas in the head space of the tank), and the accumulative pressure at the bottom of the pressurized tank is up to the combined pressure of the gas in the head space, plus the liquid pressure of the tank.

In an illustrative non-limiting embodiment, a tank, such as one having a flat bottom, is constructed to have one or more pits for collecting settled solids inside the tank. Such pits are preferably (but not necessarily) positioned at the periphery of the tank, such that a settled-solid moving system inside the tank may be employed to scrape settled solids into the pits (such as towards the pits located at the periphery of the tank). A standpipe, preferably located outside the tank, is typically connected to a pit via a proximal pipe and an opening within the pit. The standpipe may also be connected to a discharge tank through a distal pipe. A first valve on the proximal pipe controls the flow from the pit to the standpipe, while a second valve on the distal pipe controls the flow from the standpipe to the discharge tank.

In other embodiments, tanks with other shaped bottoms, including those with cone shaped or reverse cone shaped (e.g., with a raised center) bottoms, are within the scope of the invention.

In a typical operation cycle, the first valve is opened (while the second valve is closed) such that internal liquid head and/or gas pressure of the tank forces any settled solids inside the pit through the proximal pipe to enter the (substantially) empty standpipe. Partly due to the large pressure differential, a very high flow rate is achieved at the beginning of the flush cycle, such that the settled solids (e.g., sands and grits) are quickly displaced from the pit. As the level in the standpipe rises, however, the flow gradually drops off. This allows the removal of the settled solids quickly into the standpipe and put the solids into suspension. As the flow rate drops and finally stops, the suspended solids in the standpipe will start to settle again. After a pre-determined period of time (e.g., a few minutes), the second valve is opened (while the first valve is closed), such that solids in the standpipe will quickly be re-suspended and flushed into the discharge tank under high (liquid) pressure inside the standpipe. As the flow to the discharge tank gradually slows down, the liquid level in the standpipe will reduce, making it ready for the next flush cycle. The timing and duration of the valves opening can be adjusted, and the diameters of the proximal and distal pipes may be pre-selected for different usages, different solid types, weight, and average sizes, etc.

Thus in one aspect, the invention provides a solid removal system for removing solids settled at the bottom of a tank containing a solid-liquid mix, the system comprising: (a) a pit located at the bottom of the tank, preferably near an inner peripheral region of the tank, for receiving the settled solids; and, (b) a standpipe having an opening within the pit, and a discharge mechanism that controls the discharge of the solids through the opening; wherein the standpipe is designed such that internal pressure of the tank alone is sufficient to allow the solids to discharge through the standpipe.

As used herein, “solid” includes any undesirable objects that may interfere with the operation of the tank, and are desired to be removed from the tank at least on periodic basis. The solids may have a wide size and weight range, depending on the particular type of operation of the tank and the nature of the contents inside the tank. For example, if the tank is an anaerobic digester used for anaerobically digesting manure or other organic waste material, the solids may include such undigestable materials as sand, stone, gravel, metal or plastic pieces, bones, or other inorganic foreign objects that may be found mixed with manure collected from an open pen feedlot, sewage waste, or slaughterhouse. In certain embodiments, the largest solids are able to pass through a roughly round opening having a diameter of no more than about 15, 14, 13, 12, 11, 10, 9, 8, 7, 6, 5, 4, 3, 2, or 1 cm. In certain embodiments, the average sized solids are able to pass through a roughly round opening having a diameter of no more than about 15, 14, 13, 12, 11, 10, 9, 8, 7, 6, 5, 4, 3, 2, or 1 cm.

As used herein, “solid-liquid mix” refers to a mixture having both undissolved solids and liquids. The solids may or may not be evenly distributed in the liquid phase. For example, the solids may float on a top portion of the liquid, e.g., as aggregates, and may eventually settle towards a bottom portion of the liquid after a period of time and/or after disruption of the aggregate. Alternatively, solids may be distributed relatively evenly within the liquid phase, and form a “solid-liquid suspension.” Solids of the solid-liquid suspension may also eventually settle towards a bottom portion of the liquid phase. In other cases, due to the relatively heterogeneous nature of the mixture, both aggregates and suspensions may be present in the same mixture.

The pit may have different sizes, shapes and depths, depending on specific use and design of the tank. For example, a pit may be bucket shaped with a wider opening on the top and tapers to a smaller size on the bottom. The top of the pit may be a few inches to several feet wide, and preferably is flush with the bottom of the tank to facilitate collecting the settle solids in the pit. Solids collected therein may be discharged through an opening on the wall or the bottom of the pit to the standpipe.

The pit is preferably (though not necessarily) located at or near an inner peripheral region of the bottom of the tank. It may be, but needs not to, close to the vertical wall of the tank. If more than one pits are in the tank, all pits do not need to be similarly situated in relation to the tank wall. A water jet may be installed in the pit to assist the flushing of solids in the pit through the standpipe.

The standpipe is preferably located outside the tank, and may be connected to one or more of the pits, each through a proximal pipe that has an opening with a pit. Since the system is designed to be operable on internal pressure of the tank alone, the standpipe preferably has sufficient height to accommodate contents (e.g., solid-liquid suspension) received from the tank. Preferably, discharge of the settle solids is not assisted by any power source (e.g., a pump).

In certain embodiments, the standpipe is at least about 25 feet, 30 feet, 40 feet, 45 feet, or 50 feet in height. In certain embodiments, the standpipe is designed to operate with at least about 10 psi, 15 psi, 20 psi, 25 psi or more of internal pressure of the tank. The internal pressure at the bottom of the tank (where the proximal pipe opening is connected to the pit) that can be attributed to tank content (i.e., the gauge pressure), is proportional to the level of solid-liquid mix inside the tank, and the average density of the solid-liquid mix.

The top of the standpipe may be open to the air, or may be connected to a return pipe that opens inside the tank for returning spill back to the tank, preferably through the tank side near the tank roof. In either case, the top of the standpipe may be sealed off by a valve if necessary.

The size or diameter of the standpipe may be adjusted based on the specific usage intended. For example, the standpipe may be about 10-15 inches in diameter for an anaerobic digester tank.

The flow from the tank to the standpipe (through the proximal pipe) and the flow from the standpipe to a downstream discharge tank (through a distal pipe) are controlled by a discharge mechanism. In a preferred embodiment, the discharge mechanism comprises: (a) a first valve on the proximal pipe that controls the flow from the opening to the standpipe; and, (b) a second valve on the distal pipe that controls the flow from the standpipe to the discharge tank.

In certain preferred embodiments, the first and the second valves are designed not to open at the same time, e.g., one cannot open while the other is opened, but both may be closed at the same time. This design may help to prevent accidental discharge of the tank contents. Preferably, this control mechanism may be manually overridden such that both valves can be opened at the same time.

One or both of the two valves may be automated. For example, the first valve on the proximal pipe may be set to open on pre-determined time intervals (e.g., open once every 1, 2, 3 hrs, etc.), and closes either after a pre-determined time period or closes automatically when the flow into the standpipe stops or nearly stops. The second valve may be set to open at a pre-determined time after the first valve closes, such that solids inside the standpipe may have an optimal time to settle before the second valve opens. The pre-determined time period depends on a number of factors, such as the type of the solids being removed, the time it takes for them to settle in the standpipe, etc., and can be optimized based on specific usage.

The second valve may also be automated depending on the content level in the discharge tank. For example, the discharge tank may comprise a high-low level control for controlling the opening of the second valve, such that the second valve does not accidentally open when the contents in the discharge tank is at or higher than a pre-determined volume, thus preventing overflow in the discharge tank.

In certain embodiments, the discharge mechanism may further comprise a third valve for preventing the flow or controlling the level of flow from the pit to the standpipe. This third valve may be located on the proximal pipe or inside the pit, such that the flow from the pit to the standpipe may be stopped or slowed down if necessary. Preferably, the third valve is manually controlled.

In certain embodiments, the solid removal system may further comprise a settled-solid moving system configured to move solids settled at the bottom of the tank towards the pits, such as those located at the periphery of the tank. Any of many art-recognized settled-solid moving systems may be adapted for use in the subject solid removal system.

In an exemplary embodiment, the settled-solid moving system comprises: (a) a rack, as a part of a rack and pinion assembly, disposed around an inner periphery of the tank; (b) a center pivot disposed substantially vertically and substantially centrally within the tank; (c) a shaft configured to rotate around the center pivot, the shaft comprising a solid-moving mechanism configured to move solids settled at the bottom of the tank (e.g., towards the periphery of the tank), and the shaft is: (1) at the proximal end, rotatably connected to the center pivot, and (2) at the distal end, engaged to a pinion of the rack and pinion assembly, (d) a power source (e.g., a hydraulic motor) configured to drive the pinion to move along the rack.

A rack and pinion assembly is a pair of gears which convert rotational motion into linear motion. The circular pinion engages teeth on a flat bar—the rack (which may be curved or circular in shape for installation around an inner periphery of a largely round tank). When the rack is kept stationary, as in the instant design, rotational motion applied to the pinion will cause the assembly attached to the pinion (e.g., the sweeping arm or the shaft) to move relative to the rack.

The rack and pinion assembly may be installed close to the bottom of the tank, such that sweeping blades attached to the shaft may effectively scrape the settled solids towards the pits. The rack may be installed on the wall of the tank, or may be installed on a supporting system fixed on the tank floor.

Typically, the low profile rack and pinion assembly is operable when submerged under the solid-liquid mix in the tank, and/or operable when the solid-liquid mix in the tank is being stirred. In order to prevent or reduce solid settlement on the stationary teeth of the rack, thus interfering with the engagement of the rack and pinion teeth, the teeth on the rack is preferably pointing downward to minimize accumulation of settled solids on the rack teeth.

Scraping blades attached to one or more shafts are used to move settled solids towards the pits, such as those at the tank periphery. One or more (e.g., 1, 2, 3, 4 or more) shafts may be used in the system, each attaching to and rotating around a center pivot at the proximal end of the shaft. At the distal end, the shaft is engaged to the pinion of the rack and pinion assembly, such that relative movement generated by the rack and pinion assembly rotates the shaft around the center pivot (which may be disposed substantially vertically and substantially centrally within the tank). The center pivot may comprise a multi-port hydraulic swivel to provide torque.

A power source (e.g., a hydraulic motor) may be used to drive the pinion to move along the rack, preferably in either direction as desired.

In certain embodiments, a submersible motor gearbox arrangement (e.g., a sealed electric motor and gearbox) may be used to drive the pinion. Preferably, power supply for the arrangement may run through a submersible swivel at the center pivot.

In certain embodiments, the one or more shafts are hollow. In certain embodiments, the shaft may be longer than 20, 30, 40, 50, or 60 ft.

In certain embodiments, each shaft comprises a plurality of scraping blades, each blade arranged at an angle not perpendicular to the axis of the shaft. When the shaft moves around the center pivot in circular motion, the scraping blades gradually moves the settled solids towards the pits. For example, in a preferred (but non-limiting) embodiment, the angles can be designed to remove settled solids from more centrally located positions towards the peripheral regions, and ultimately pushing the settled solids into the pit at the tank periphery.

In certain embodiments, all the scraping blades are parallel to each other. In other embodiments, at least two of the plurality of scraping blades are not parallel to each other. This latter embodiments may be more efficient in certain conditions, where more centrally (proximally) located scraping blades may face less resistance from less amount of settled solids, and more peripherally (distally) located scraping blades may face more resistance from larger amounts of accumulated solids.

Preferably, the angle of each scraping blade may be individually or collectively adjustable.

In certain embodiments, to facilitate more efficient dropping of the settled solids into the pit, the solid-moving mechanism may comprise a scraping cup at the distal end of the shaft, wherein solids trapped in the scraping cup are positioned to fall into the pit when the distal end of the shaft passes over the pit.

In certain embodiments, the discharge tank may comprise a stirring mechanism to prevent the organic materials from settling in the discharge tank. Preferably, the discharge tank is configured to return a liquid and/or a gas back to the tank. For example, the discharge tank may be a closed tank with a roof vent, such that any gas (such as methane and CO₂ from anaerobic digestion) can return to the tank through a roof opening.

In certain embodiments, the settled solids in the discharge tank can be discharged via a screw conveyer. The screw conveyer may be any art-recognized models, and may be commercially available. It preferably selectively conveys solid while tending to leave liquid behind, which liquid may be collected and returned to the tank.

Another aspect of the invention provides a method for removing solids settled at the bottom of a tank containing a solid-liquid mix, the method comprising: (a) collecting the solids in a pit located at (or near an inner peripheral region of) the bottom of the tank; and, (b) discharging the solids in the pit through an opening of a standpipe, the opening is inside the pit, and the open and closure of the opening is controlled by a discharge mechanism; wherein the standpipe is designed such that internal pressure of the tank alone is sufficient to allow the solids to discharge through the standpipe.

In certain embodiments, the discharge mechanism comprises: (a) a first valve on a proximal pipe that controls the flow from the opening to the standpipe; and, (b) a second valve on a distal pipe that controls the flow from the standpipe to a discharge tank; wherein the first valve and the second valve are designed not to open at the same time.

In certain embodiments, step (b) is effected by: (1) opening the first valve to allow the internal pressure of the tank to flush the solids in the pit to the standpipe; (2) closing the first valve and opening the second valve to allow the pressure inside the standpipe to flush the solids in the standpipe to the discharge tank.

In certain embodiments, the solids are collected in the pit using a settled-solid moving system configured to move solids settled at the bottom of the tank towards the pits, such as those located at the periphery of the tank.

1. A solid removal system for removing solids settled at the bottom of a tank containing a solid-liquid mix, said system comprising:
(a) a pit located at the bottom of the tank, for receiving said solids settled at the bottom of said tank containing said solid-liquid mix; and,
(b) a standpipe having an opening within the pit, and a discharge mechanism that controls the discharge of said solids through said opening;
wherein said standpipe is designed such that internal pressure of the tank alone is sufficient to allow said solids to discharge through the standpipe.

2. The solid removal system of claim 1, wherein the height of the standpipe is at least about 25 feet, 30 feet, 40 feet, 45 feet, or 50 feet.

3. The solid removal system of claim 1, wherein the standpipe is designed to operate with at least about 10 psi, 15 psi, 20 psi, 25 psi or more of internal pressure of the tank.

4. The solid removal system of claim 1, wherein the standpipe is connected to the opening within the pit through a proximal pipe, and connected to a discharge tank for receiving the solids through a distal pipe.

5. The solid removal system of claim 4, wherein the discharge mechanism comprises:
(a) a first valve on the proximal pipe that controls the flow from the opening to the standpipe; and,
(b) a second valve on the distal pipe that controls the flow from the standpipe to the discharge tank.

6. The solid removal system of claim 5, wherein said first valve and said second valve are designed not to open at the same time.

7. The solid removal system of claim 5, wherein at least one of the first valve and the second valve is automated.

8. The solid removal system of claim 5, wherein the discharge tank comprises a high-low level control for controlling the opening of said second valve, such that said second valve is designed not to open when the contents in the discharge tank is at or higher than a pre-determined volume.

9. The solid removal system of claim 4, wherein the discharge mechanism comprises a third valve for preventing the flow or controlling the level of flow from the opening to the standpipe.

10. The solid removal system of claim 1, wherein the top of the standpipe further comprises a return pipe for returning excessive contents back to the tank.

11. The solid removal system of claim 1, further comprising a settled-solid moving system configured to move solids settled at the bottom of the tank towards the pit.

12. The solid removal system of claim 11, wherein the settled-solid moving system comprises:
(a) a rack, as a part of a rack and pinion assembly, disposed around an inner periphery of the tank;
(b) a center pivot disposed substantially vertically and substantially centrally within the tank;
(c) a shaft configured to rotate around the center pivot, said shaft comprising a solid-moving mechanism configured to move solids settled at the bottom of the tank towards the pit, and said shaft is:
(1) at the proximal end, rotatably connected to the center pivot, and
(2) at the distal end, engaged to a pinion of the rack and pinion assembly,
(d) a power source (e.g., a hydraulic motor) configured to drive the pinion to move along the rack.

13. The solid removal system of claim 12, wherein the rack and pinion assembly is submerged when the tank is filled with the solid-liquid suspension.

14. The solid removal system of claim 12, wherein the teeth of the rack point downward to engage the pinion.

15. The solid removal system of claim 12, wherein the rack is fixed on the bottom of the tank, or on the wall of the tank.

16. The solid removal system of claim 12, wherein the shaft is hollow.

17. The solid removal system of claim 12, wherein the solid-moving mechanism comprises a plurality of scraping blades, each arranged at an angle not perpendicular to the axis of the shaft.

18. The solid removal system of claim 12, wherein all the scraping blades are parallel to each other.

19. The solid removal system of claim 12, wherein at least two of the plurality of scraping blades are not parallel to each other.

20. The solid removal system of claim 12, wherein the angle of each scraping blade is individually adjustable.

21. The solid removal system of claim 12, wherein the solid-moving mechanism comprises a scraping cup at the distal end of the shaft, wherein solids trapped in the scraping cup are positioned to fall into the pit when the distal end of the shaft passes over the pit.

22. The solid removal system of claim 12, wherein the shaft is longer than 20, 30, 40, 50, or 60 ft.

23. The solid removal system of claim 12, wherein the power source is configured to drive the pinion to move along the rack in either direction.

24. The solid removal system of claim 12, wherein the center pivot comprises a multi-port hydraulic swivel to provide torque.

25. The solid removal system of claim 12, wherein settled-solid moving system comprises two or more shafts.

26. The solid removal system of claim 1, wherein the bottom of the tank is flat.

27. The solid removal system of claim 1, further comprising a water jet in the pit to assist the flushing of solids in the pit through the standpipe.

28. The solid removal system of claim 1, comprising two or more pits.

29. The solid removal system of claim 1, wherein the tank is an anaerobic digester tank, and the solid-liquid mix is organic waste undergoing anaerobic digestion.

30. The solid removal system of claim 29, configured to operate and remove solids settled at the bottom of the tank during an active anaerobic digestion.

31. The solid removal system of claim 29, wherein said solids settled at the bottom of the tank comprise rock, stone, metal, and other inorganic material not conductive for anaerobic digestion.

32. The solid removal system of claim 1, which operates when the solid-liquid suspension in the tank is being stirred.

33. The solid removal system of claim 1, wherein the standpipe is configured to accelerate the initial discharge of the settled solids under the pressure of the solid-liquid suspension, and configured to prevent excessive discharge when the level in the standpipe approaches the solid-liquid suspension level inside the tank.

34. The solid removal system of claim 33, wherein discharge of the settle solids is not assisted by any power source (e.g., a pump).

35. The solid removal system of claim 1, wherein the standpipe is connected to a discharge tank for receiving solids removed from the tank.

36. The solid removal system of claim 35, wherein the discharge tank comprises a stirring mechanism.

37. The solid removal system of claim 35, wherein the discharge tank is configured to return a liquid and/or a gas back to the tank.

38. The solid removal system of claim 35, wherein settled solids in the discharge tank are discharged via a screw conveyer.

39. A method for removing solids settled at the bottom of a tank containing a solid-liquid mix, said method comprising:
(a) collecting said solids in a pit located at the bottom of the tank; and,
(b) discharging the solids in the pit through an opening of a standpipe, said opening is inside the pit, and the open and closure of the opening is controlled by a discharge mechanism;
wherein said standpipe is designed such that internal pressure of the tank alone is sufficient to allow said solids to discharge through the standpipe.

40. The method of claim 39, wherein the discharge mechanism comprises:
(a) a first valve on a proximal pipe that controls the flow from the opening to the standpipe; and,
(b) a second valve on a distal pipe that controls the flow from the standpipe to a discharge tank;
wherein said first valve and said second valve are designed not to open at the same time.

41. The method of claim 40, wherein step (b) is effected by:
(1) opening the first valve to allow the liquid pressure inside the tank to flush the solids in the pit to the standpipe;
(2) closing the first valve and opening the second valve to allow the pressure inside the standpipe to flush the solids in the standpipe to the discharge tank.

42. The method of claim 39, wherein the solids are collected in the pit using a settled-solid moving system configured to move solids settled at the bottom of the tank towards the pit.
